(19) United States
(12) Patent Application Publication
(10) Pub. No.: US 2013/0202420 A1
(43) Pub. Date: Aug. 8, 2013

(54) Turbine Shell Having A Plate Frame Heat Exchanger

(71) Applicant: Donald Earl Floyd, Greenville, SC (US)

(72) Inventor: Donald Earl Floyd, Greenville, SC (US)

(73) Assignee: GENERAL ELECTRIC COMPANY, Schenectady, NY (US)

(21) Appl. No.: 13/367,976

(22) Filed: Feb. 7, 2012

(51) Int. Cl. F02C 7/12; F01D 25/24

(52) U.S. Cl. 415/177

(57) ABSTRACT

A turbine shell is provided, and includes a body portion and at least one plate. The body portion has a forward portion and an aft portion. The plate is located between the forward portion and the aft portion. The plate is part of a plate frame heat exchanger, which is part of the body portion of the turbine shell.

### BACKGROUND OF THE INVENTION

The subject matter disclosed herein relates to a turbine shell, and more specifically to a turbine shell having a plate frame heat exchanger.

Gas turbines generally include a compressor, a combustor, one or more fuel nozzles, and a turbine. Air enters the gas turbine through an air intake and is compressed by the compressor. The compressed air is then mixed with fuel supplied by the fuel nozzles. The air-fuel mixture is supplied to the combustors at a specified ratio for combustion. The combustion generates pressurized exhaust gases, which drive blades of the turbine.

The gas turbine generally includes an outer turbine shell and an inner turbine shell. The outer turbine shell and the inner turbine shell expand and contract in a radial direction relative to a turbine rotor during operation of the gas turbine. A radial clearance that is located between tips of rotating blades and the inner turbine shell affects the efficiency of the gas turbine, where a smaller clearance may improve efficiency. However, a smaller clearance may also increase the likelihood that an interference condition is created between the inner turbine shell and the tips of the rotating blade. Active clearance control is an approach that regulates the temperature of the inner turbine shell, which in turn controls the clearance between the tips of the rotating blades and the inner turbine shell. Several approaches are currently available to provide active clearance control for the inner turbine shell, however some of these approaches have drawbacks. For example, in one approach direct impingement cooling may be employed. However, this approach is usually not as effective when employed in a gas turbine.

### BRIEF DESCRIPTION OF THE INVENTION

According to one aspect of the invention, a turbine shell is provided, and includes a body portion and at least one plate. The body portion has a forward portion and an aft portion. The at least one plate is located between the forward portion and the aft portion. The at least one plate is part of a plate frame heat exchanger that is part of the body portion of the turbine shell.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an exemplary gas turbine system having a compressor;

FIG. 2 is a perspective view of a section of an inner turbine shell of a turbine illustrated in FIG. 1;

FIG. 3 is an illustration of the section of the inner turbine shell shown in FIG. 2;

FIG. 4 is another illustration of the section of the inner turbine shell shown in FIG. 2;

FIG. 5 is yet another illustration of the section of the inner turbine shell shown in FIG. 2; and

FIG. 6 is a front view of a portion of the section of the inner turbine shell shown in FIG. 2.

The detailed description explains embodiments of the invention, together with advantages and features, by way of example with reference to the drawings.

### DETAILED DESCRIPTION OF THE INVENTION

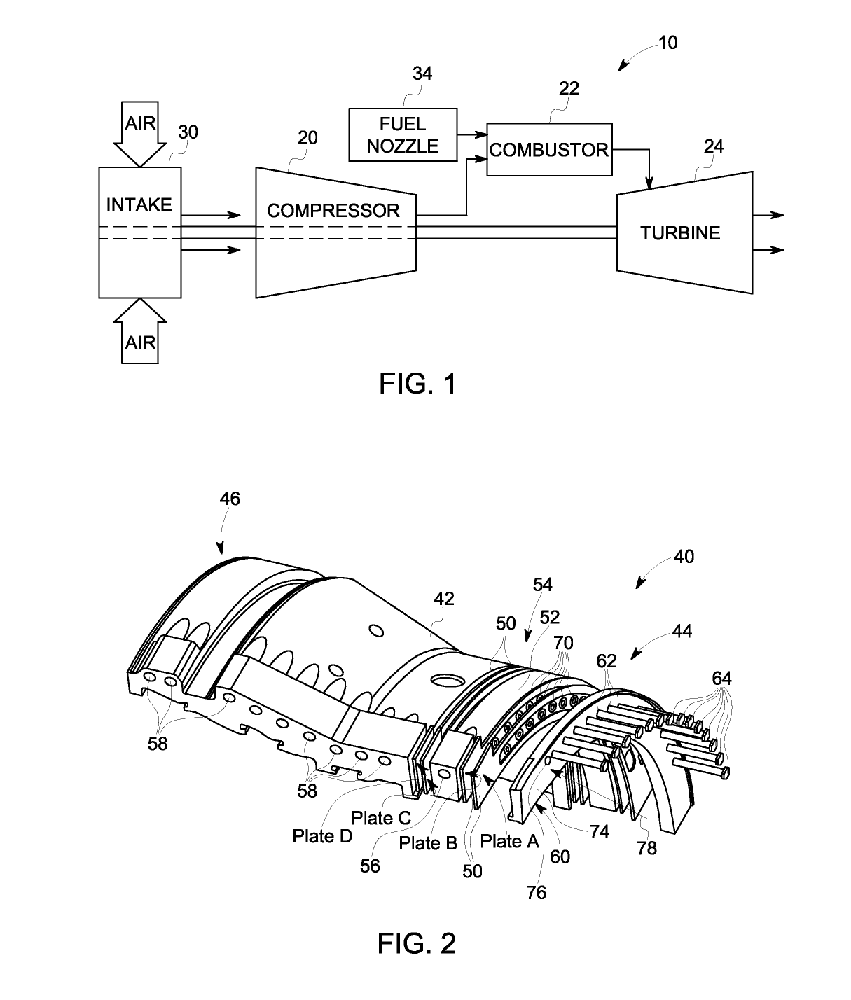

FIG. 1 illustrates a schematic exemplary power generation system indicated by reference number 10. The power generation system 10 is a gas turbine system having a compressor 20, a combustor 22, and a turbine 24. Air enters the power generation system 10 though an air intake 30 connected to the compressor 20, and is compressed by the compressor 20. The compressed air is then mixed with fuel by a fuel nozzle 34. The fuel nozzle 34 injects an air-fuel mixture into the combustor 22 in a specific ratio for combustion. The combustion generates hot pressurized air exhaust that drives blades (not shown) that are located within the turbine 24.

FIG. 2 is an illustration of a section of an inner turbine shell 40 of the turbine 24 (shown in FIG. 1). The inner turbine shell 40 includes a body portion 42 having a forward portion 44 and an aft portion 46. In one embodiment, the inner turbine shell 40 includes a generally circumferential configuration and is partitioned into quarter sections, where one of the quarter sections is illustrated in FIG. 2. Although FIG. 2 illustrates a quarter section of the inner turbine shell 40, it is to be understood that the inner turbine shell 40 may be sectioned in other configurations as well such as, for example, half sections. The body portion 42 may be constructed from a material intended for relatively high temperature applications. For example, in one embodiment the inner turbine shell 40 is constructed from chromium-molybdenum-vanadium (“CrMoV”) steel.

In one embodiment, each of the sections of the inner turbine shell 40 may be joined together by an axially oriented bolted connection. Specifically, a central piece 52 of the plate frame heat exchanger assembly 54 includes a fastener aperture 56 for receiving a fastener such as a bolt (not shown). The body portion 42 of the inner turbine shell 40 may also include a series of fastener apertures 58 as well, where each of the fastener apertures 58 receives an axially oriented bolt (not shown). A bolted connection may provide a relatively tight tolerance for a generally leak-free joint between the sections of the inner turbine shell 40 during operation. Although a bolted connection is discussed, it is to be understood that other fastening approaches that result in a relatively tight tolerance for a generally leak free operation may be used as well to join the sections of the inner turbine shell 40.

At least one plate 50 is located between the forward portion 44 and the aft portion 46 of the inner turbine shell 40. In the exemplary embodiment as shown, a total of four plates 50 are illustrated as well as the central piece 52, and are labeled from the forward portion 44 to the aft portion 46 as Plate A, Plate B, Plate C, and Plate D. The plates 50 as well as the central piece 52 are part of a plate frame heat exchanger 54. Specifically, the plate frame heat exchanger 54 is located adjacent the forward portion 44 of the inner turbine shell 40 such that the plate frame heat exchanger 54 is located closer to the forward portion 44 when compared to the aft portion 46. The plate frame heat exchanger 54 may be any type of heat exchanger that uses plates for the transfer of heat between two mediums such as gas or a liquid. The plate frame heat exchanger 54 is part of the body portion 42 of the inner turbine shell 40. In one embodiment, high temperature brazes, welds, or metal seals (not shown) may be used to join the plates 50 of the plate frame heat exchanger 54 together. It should be noted that while FIG. 2 illustrates an inner turbine shell 40, it is to be understood that the plate frame heat exchanger 54 may be used at least in some embodiments on an outer turbine shell (not shown) of the turbine 24 (FIG. 1) as well.

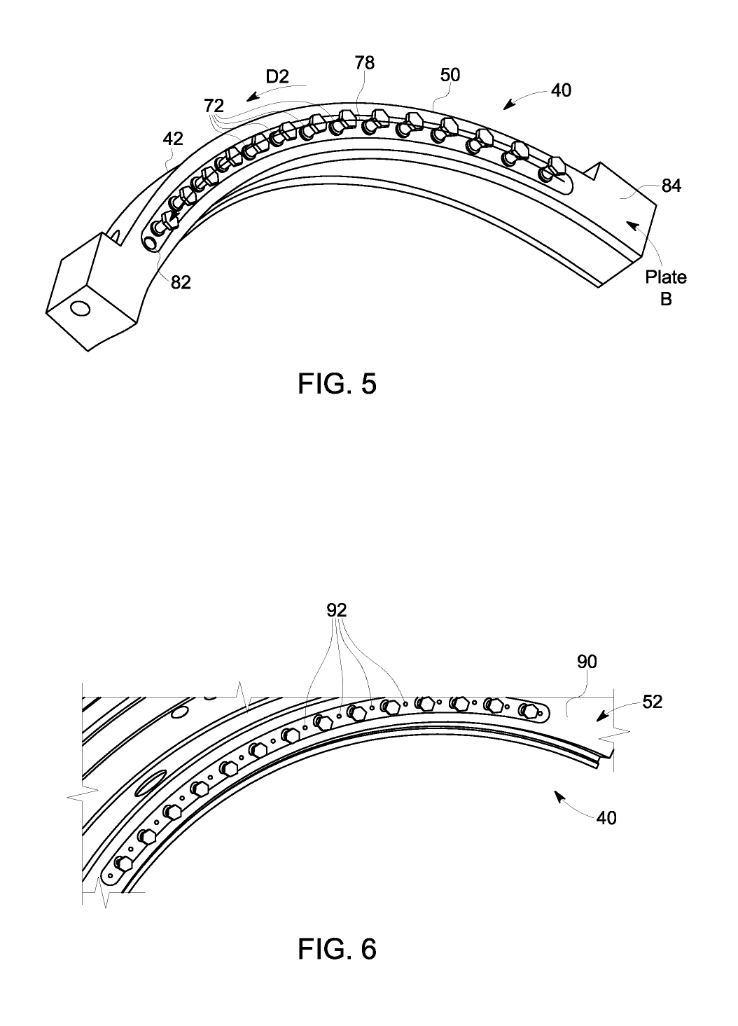

A head flange 60 is located at the forward portion 44 of the inner turbine shell 40. The head flange 60 includes a plurality of fastener openings 62 that are each configured for receiving a fastener 64 therethrough for coupling the plates 50, the central piece 52, and the head flange 60 together. Specifically, the fastener openings 62 may be threadingly engaged with the fasteners 64. In the exemplary embodiment as shown in FIG. 2, the fasteners 64 are bolts, however other types of fastening approaches may be used as well. The plates 50 also include fastener openings 70 for receiving the fasteners 64, and the central piece 52 also includes fastener openings 72 (shown in FIG. 5) for receiving the fasteners 64.

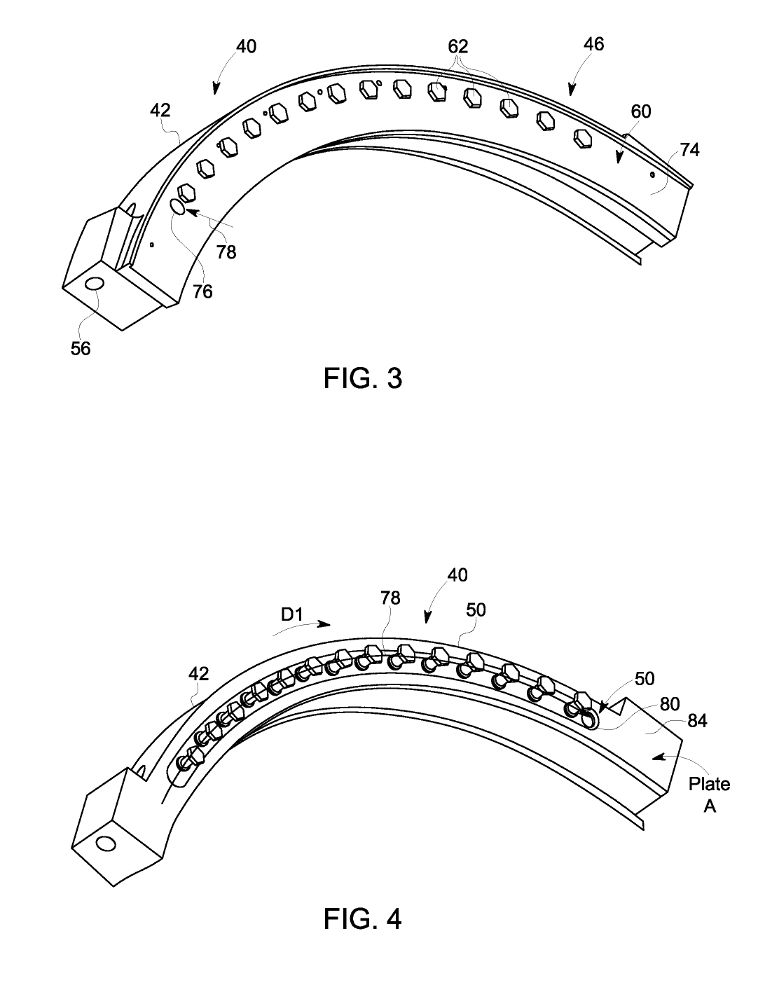

Referring now to both FIGS. 2-3, a forward face 74 of the head flange 60 includes a cooling aperture 76 for receiving a diffusion or cooling flow 78. The cooling flow 78 may be, for example, ambient air that is introduced from the atmosphere, steam, a pressurized coolant in a liquid state, or bleed air from the compressor 20 (shown in FIG. 1). In one embodiment, the cooling flow 78 generally includes a temperature that is greater than about 205° C. (about 400° F.). Having a cooling flow that is generally above about 205° C. will substantially prevent a relatively large amount of thermal stress from being created within the inner turbine shell 40.

The cooling flow 78 is supplied to the plate frame heat exchanger 54 though the cooling aperture 76 located in the head flange 60. That is, the head flange 60 acts as a manifold for receiving the cooling flow 78 for the plate frame heat exchanger 54. Although FIG. 3 illustrates a cooling aperture 76, it is to be understood that other approach may be used as well to introduce the cooling flow 78 into the plate frame heat exchanger 54 (shown in FIG. 2). For example, in another embodiment, a series of passageways (not shown) may be provided along the head flange 60 for the ingression of the cooling flow 78.

FIG. 4 is an illustration of the inner turbine shell 40 with the head flange 60 omitted to reveal one of the plates 50 that is designated as Plate A (Plate A is also shown in FIG. 2). Referring to FIGS. 2-4, the cooling flow 78 enters the plate frame heat exchanger 54 through the cooling aperture 76, and then flows in the direction D1 as indicated in FIG. 4, in a generally circumferential direction. That is, the cooling flow 78 includes a flow path that is generally circumferential in travel. Although FIGS. 3-4 illustrate a relatively simple circumferential flow path, it is to be understood that specific features (not shown) may be machined or stamped along a heat transfer or outer surface 84 of the plates 50 as well to create a more complex flow path including, but not limited to, louvered surfaces, serpentine flowpaths, chevron flow paths, pin-fin surfaces, finned surfaces, and the like.

The cooling flow 78 then enters a cooling aperture 80 located within Plate A. Referring now to FIG. 5, Plate A has been omitted to reveal Plate B (shown in FIG. 2). The cooling flow 78 travels in a direction D2 that generally opposes the direction D1 (shown in FIG. 4), and enters a cooling aperture 82 that is located within Plate B. Thus, the plates 50 (e.g., Plate A in FIG. 4 and Plate B in FIG. 5) are fluidly connected to one another. In one embodiment, one or more of the plates 50 may include extended surfaces (not shown) that project outwardly along the outer surface 84 of the plates 50. For example, in one embodiment, the outer surface 84 of the plates 50 may include fins that provide enhanced cooling. Also, in another embodiment, instead of the single, unitary cooling apertures 80 and 82 located along the outer surfaces 84 of Plate A and Plate B (shown in FIGS. 4 and 5), the plates 50 may include a series of passageways that allow for the cooling flow 78 to flow between the plates 50.

Referring now to FIGS. 2 and 4-5, each of the plates 50 are fluidly connected to one another, as well as the central piece 52. Specifically, in the embodiment as shown in FIGS. 2 and 4-5, the cooling flow 78 flows between Plate A, Plate B, and the central piece 52. The central piece 52 provides circumferential support to the plate frame heat exchanger 54. The central piece 52 also includes internal manifolding, which is shown in FIG. 6.

FIG. 6 is an enlarged view frontal view of an outer surface 90 of the central piece 52, where the head flange 60, Plate A, and Plate B have been omitted. As seen in FIG. 6, the outer surface 90 includes a series of passageways 92 that provide internal manifolding. The coolant flow 78 (shown in FIGS. 2-5) may flow through the passageways 92, and to Plate C and Plate D (shown in FIG. 2).

The plate frame heat exchanger 54 as shown in FIGS. 2-6 provides active clearance control as well as circumferential cooling of the inner turbine shell 40. The plate frame heat exchanger 54 allows for flow channel cooling if the heat transfer surfaces 84 of the plates 50 are contaminated or fouled, however, the plate frame heat exchanger 54 includes a plate configuration that is relatively simple to clean and maintain. The geometry of the plates 50 may be modified to create relatively complex cooling flow paths as well. Moreover, the plate frame heat exchanger 54 is modular in design, and is relatively simple to retrofit on an existing inner turbine shell.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbine shell, comprising:
a body portion having a forward portion and an aft portion;
at least one plate located between the forward portion and the aft portion, the at least one plate being part of a plate frame heat exchanger that is part of the body portion of the turbine shell.

2. The turbine shell as recited in claim 1, wherein the plate frame heat exchanger includes a central piece portion that is fluidly connected to the at least one plate.

3. The turbine shell as recited in claim 2, wherein the plate frame heat exchanger includes a plurality of plates, wherein the plurality of plates are fluidly connected to one another and the central piece portion.

4. The turbine shell as recited in claim 2, wherein the central piece portion includes internal manifolding where a series of passageways are provided therethrough in the central piece portion.

5. The turbine shell as recited in claim 1, wherein the at least one plate is located closer to the forward portion when compared to the aft portion.

6. The turbine shell as recited in claim 1, wherein the plate frame heat exchanger receives a diffusion flow, wherein the diffusion flow is at least one of ambient air, steam, a pressurized coolant in a liquid state, and bleed air from a compressor of a turbine.

7. The turbine shell as recited in claim 6, wherein the diffusion flow includes a flow path that is generally circumferential.

8. The turbine shell as recited in claim 1, wherein an outer surface of the at least one plate includes an extended surface that projects outwardly to provide cooling.

9. The turbine shell as recited in claim 1, wherein the turbine shell is an inner turbine shell configured for a gas turbine.

10. A gas turbine having an inner turbine shell, comprising:
a body portion having a forward portion and an aft portion;
at least one plate located between the forward portion and the aft portion, the at least one plate being part of a plate frame heat exchanger that is part of the body portion of the inner turbine shell.

11. The turbine shell as recited in claim 10, wherein the plate frame heat exchanger includes a central piece portion that is fluidly connected to the at least one plate.

12. The gas turbine as recited in claim 11, wherein the plate frame heat exchanger includes a plurality of plates, wherein the plurality of plates are fluidly connected to one another and the central piece portion.

13. The gas turbine as recited in claim 11, wherein the central piece portion includes internal manifolding where a series of passages are provided therethrough in the central piece portion.

14. The gas turbine as recited in claim 10, wherein the at least one plate is located closer to the forward portion when compared to the aft portion.

15. The gas turbine as recited in claim 10, wherein the plate frame heat exchanger receives a diffusion flow, wherein the diffusion flow is at least one of ambient air, steam, a pressurized coolant in a liquid state, and bleed air from a compressor of a turbine.

16. The gas turbine as recited in claim 15, wherein the diffusion flow includes a flow path that is generally circumferential.

17. The gas turbine as recited in claim 10, wherein an outer surface of the at least one plate includes an extended surface that projects outwardly to provide cooling.

18. A gas turbine having an inner turbine shell, comprising:
a body portion having a forward portion and an aft portion; and
a plate frame heat exchanger that is part of the body portion of the inner turbine shell, the plate frame heat exchanger including:
a plurality of plates located between the forward portion and the aft portion, the plurality of plates fluidly connected to one another; and
a central piece portion that is fluidly connected to the plurality of plates.

19. The gas turbine as recited in claim 18, wherein the central piece portion includes internal manifolding where a series of passages are provided therethrough in the central piece portion.

20. The gas turbine as recited in claim 18, wherein the plate frame heat exchanger receives a diffusion flow, wherein the diffusion flow is at least one of ambient air, steam, a pressurized coolant in a liquid state, and bleed air from a compressor of a turbine.
